(19) United States
(12) Patent Application Publication
(10) Pub. No.: US 2026/0289349 A1
(43) Pub. Date: Sep. 24, 2026

(54) SYSTEM AND METHOD FOR AUTOMATED DATA VERIFICATION USING MULTIPLE ARTIFICIAL INTELLIGENCE ENGINES

(71) Applicant: SoftWorks AI, LLC, Forest Hills, NY (US)

(72) Inventors: Ari Gross, West Hempstead, NY (US); Dweej Patel, Glen Oaks, NY (US); Yuhnao Shi, New Hyde Park, NY (US); Siavash Zokai, Jackson Heights, NY (US); Navdeep Singh Tinna, Mississauga (CA)

(21) Appl. No.: 19/569,563

(22) Filed: Mar. 17, 2026

Related U.S. Application Data
(60) Provisional application No. 63/773,787, filed on Mar. 18, 2025.

(51) Int. Cl. G06N 5/04; G06F 18/21

(52) U.S. Cl. CPC G06N 5/04; G06F 18/217

(57) ABSTRACT

Systems and methods are provided for automated analysis of an electronic document or other computer-readable data using multiple artificial intelligence (AI) engines. A data ingestor received computer-readable data and provides the received data to a first AI engine that produces a first result using a first algorithm and to a second AI engine that produces a second result using a second algorithm that is substantially uncorrelated or orthogonal to the first AI algorithm. A comparison generator compares the first result and the second result to generate a matching value. A decision generator analyzes the first and second result and matching value and, based on such analysis, makes a decision on whether to generate a final result or to escalate the process to a next level, such as a manual review by a human reviewer or an automated analysis by a third AI engine running a third AI algorithm that is uncorrelated (or substantially uncorrelated) to both the first and second AI algorithms. An optional verification record generator may be used to generate a verification record that may be further cryptographically secured by a cryptographic encoder.

### REFERENCES TO RELATED APPLICATIONS

The present application claims the benefit of U.S. provisional Application No. 63/773,787 filed Mar. 18, 2025, the disclosure of which is fully incorporated herein by reference.

### BACKGROUND

The present disclosure relates generally to computer-implemented systems and methods for automated analysis of computer-readable data, such as electronic documents. More particularly, the disclosure relates to automated data-processing architectures that employ multiple artificial intelligence (AI) engines to generate respective processing results for a common input and to compare such results to support automated acceptance of a final result for downstream enterprise automated workflows.

In many enterprise environments, including regulated industries, electronic documents and associated data are processed and verified using AI tools for tasks such as document classification, splitting, versioning, stacking, and data extraction, as well as validation of extracted information. Such tools may include deterministic machine learning methods, such as expert-system logic, while others may use probabilistic machine learning methods, such as large-language-model (LLM) and other generative AI techniques. These approaches can accelerate review and interpretation of documents, including unstructured or scanned documents.

However, automated workflows that rely on a single AI process may be constrained by an inability to independently assess the correctness of the generated work product. In some implementations, even when average accuracy of an engine or model is high, a system may be unable to reliably distinguish which particular outputs are correct and which outputs are incorrect. As a result, outputs may remain subject to extensive verification, thereby limiting the extent to which human touch points can be reduced in practice. In addition, some AI techniques may generate untrusted or inconsistent outputs under certain conditions, including conditions that involve ambiguity, incomplete information, or document noise, and such risks may be difficult to mitigate using only explainability or internal confidence measures of a single engine.

Accordingly, there is a need for automated data-processing techniques that can provide an independent verification mechanism suitable for determining whether an automated processing result may be accepted for downstream use. There is also a need for architectures that can synthesize outputs from two or more uncorrelated or orthogonal methods, compare such outputs to produce an agreement measure, and apply decision logic to select an accepted final result or to trigger escalation when agreement is insufficient.

### SUMMARY

The following presents a simplified summary in order to provide a basic understanding of some aspects of the disclosed subject matter.

In some embodiments, an automated data analysis system includes an ingestion module configured to receive computer-readable data (e.g., an electronic document or a loan file) and to provide the received data to a first AI engine and a second AI engine for separate processing. The first AI engine processes the received data using a first AI algorithm to generate a first result, and the second AI engine processes the received data using a second AI algorithm to generate a second result, where the second AI algorithm is substantially uncorrelated with, or substantially orthogonal to, the first AI algorithm. The system further includes a decision generator coupled to the first AI engine and the second AI engine, the decision generator configured to generate a final result based on the first result and the second result.

In some embodiments, an automated data analysis system includes an ingestion module configured to receive computer-readable data (e.g., an electronic document or a loan file) and to provide the received data to a first AI engine and a second AI engine for separate processing. The first AI engine processes the received data using a first AI algorithm to generate a first result, and the second AI engine processes the received data using a second AI algorithm to generate a second result, where the second AI algorithm is substantially uncorrelated with, or substantially orthogonal to, the first AI algorithm. The system further includes a comparison generator coupled to outputs of the first and second AI engines and configured to generate a matching value based on the first result and the second result, and a decision generator coupled to the comparison generator and configured to generate a final result based on the matching value.

In some implementations, the system is configured such that the final result has a final confidence value that is greater than at least one of (i) a confidence value of the first result or (ii) a confidence value of the second result. In some implementations, the first AI algorithm is a depth-first AI algorithm, and the second AI algorithm is a breadth-first AI algorithm. In some implementations, the depth-first AI engine uses a deterministic, expert-system, algorithm and the breadth-first AI algorithm used a probabilistic algorithm, such as a large-language-model (LLM) algorithm. The breadth-first AI engine comprises a number of layers, including a transformer layer. In some implementations, the depth-first AI engine comprises a number of layers, including a rule-based layer.

In some embodiments, an automated data analysis method includes receiving computer-readable data; processing the received computer-readable data using a first AI engine running a first AI algorithm to produce a first result having a first confidence value; and separately processing the received computer-readable data using a second AI engine running a second AI algorithm that is substantially uncorrelated with the first AI algorithm to produce a second result having a second confidence value. The method further includes analyzing the first result and the second result to produce a matching value and, based on the matching value, producing a final result having a final confidence value that is greater than at least one of (i) the first confidence value and/or (ii) the second confidence value.

In some implementations of the method, the first AI algorithm is a depth-first AI algorithm, and the second AI algorithm is a breadth-first AI algorithm. In some implementations, the depth-first AI engine uses a deterministic, expert-system algorithm, and the breadth-first AI engine uses a probabilistic algorithm, such as a large-language-model (LLM) algorithm.

In some implementations, the system or method further includes generating a verification record, which may include one or more of the following: the results of each individual engine and their respective confidence values, a matching value, the final result and its confidence value. In some implementations, the verification record has a JSON format. In some implementations, the system further includes a cryptographic encoder, and the method further includes cryptographically securing the verification record.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The present invention is illustrated by way of example, and not by way of limitation, in the figures of the accompanying drawings in which like reference numerals refer to similar elements, and in which:

FIG. 1 is a schematic diagram illustrating a networked computing environment in which the present invention operates.

FIG. 2 is a block diagram illustrating an embodiment of an automated data analysis system of the present invention.

FIG. 3 is a block diagram illustrating an embodiment of depth-first AI engine that may be used in the present invention.

FIG. 4 is a block diagram illustrating an embodiment of breadth-first AI engine that may be used in the present invention.

FIG. 5 is a flow diagram illustrating an embodiment of comparison generator for use in the present invention.

FIG. 6 is a flow diagram illustrating an embodiment of decision generator for use in the present invention.

FIG. 7 is a block diagram illustrating an embodiment of server architecture for use in a system of the present invention.

### DETAILED DESCRIPTION

Before the present systems, devices, and/or methods are disclosed and described, it is to be understood that the aspects described below are not limited to specific methods and, as such may, of course, vary. It is also to be understood that the terminology used herein is for the purpose of describing particular aspects only and is not intended to be limiting.

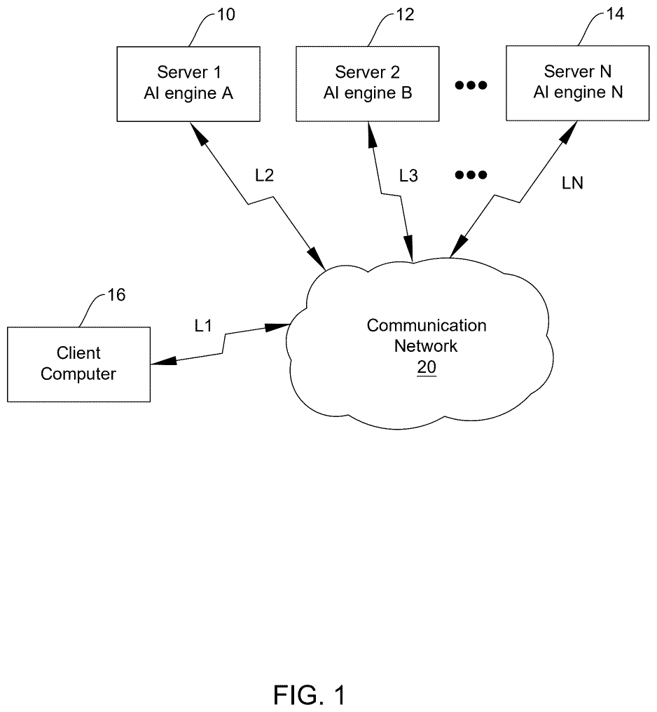

FIG. 1 is a schematic diagram illustrating a networked computing environment in which client computer 16 communicates with a plurality of servers that execute respective AI (AI) engines, including server 1 (AI engine A) label 10, server 2 (AI engine B) label 12, and server N (AI engine N) label 14. Communication network 20 provides a data-transport layer between client computer 16 and the plurality of servers, permitting client computer 16 to submit computer-readable data for analysis and to receive one or more processing results produced by the AI engines executing on the servers. Additionally, the plurality of servers may be deployed as separate physical computing nodes, as virtual machines, as containers, or as other computing instances that expose network-accessible interfaces for receiving computer readable data, such as electronic documents, returning outputs, and exchanging verification artifacts used by the multi-engine comparison and decision logic described elsewhere herein.

According to an embodiment, client computer 16 includes a workstation, a laptop, a mobile device, or an application server that originates a request to process an electronic document, a loan file, or other computer-readable data. Client computer 16 is coupled to communication network 20 via communication link L1, which supports bidirectional exchange of requests and responses between client computer 16 and network endpoints associated with the plurality of servers. Additionally, communication link L1 and communication network 20 may support transport connections using one or more wired Ethernet, wireless networking, cellular networking, or virtual private network tunneling, and may carry data payloads that include document binaries, document references, metadata describing document type, and identifiers used to correlate results returned from different AI engines.

In some embodiments, server 1 (AI engine A) label 10 is coupled to communication network label 20 via communication link L2, server 2 (AI engine B) label 12 is coupled to communication network 20 via communication link L3. The system may include one or more additional servers, conceptually illustrated in FIG. 1 as server N (AI engine N) label 14 coupled to communication network 20 via communication link Ln. Each communication link L2, communication link L3, and communication link Ln may represent a logical connection, a routed path, or a session-based transport channel established over communication network 20. Additionally, communication network 20 may include one or more of a local-area network, a wide-area network, a cloud network fabric, and one or more load-balancing or gateway components that route requests from client computer 16 to one or more of server 1 (AI engine A) label 10, server 2 (AI engine B) label 12, and server N (AI engine N) label 14 based on endpoint selection rules, service discovery, or tenant configuration.

According to an embodiment, the plurality of servers shown in FIG. 1 supports a distributed implementation of the multi-engine architecture in which different AI engines execute on different server nodes and process a common input in parallel or near parallel. For example, server 1 (AI engine A) label 10 may execute a first AI algorithm and server 2 (AI engine B) label 12 may execute a second, different, AI algorithm. Server N (AI engine N) label 14 may execute a further AI algorithm for auxiliary processing. The deployed engines can be selected to exhibit reduced correlation in error modes by using different model architectures, different inference pathways, different parsing strategies, or different training sources, such that agreement between outputs received from multiple servers provides a machine-implemented verification signal used by downstream comparison and threshold logic.

In one aspect, FIG. 1 illustrates how the first AI engine and the second AI engine can be implemented as separate network-addressable services running on different ones of server 1 (AI engine A) label 10 and server 2 (AI engine B) label 12, with exchanges carried over communication network label 20. Additionally, server 1 (AI engine A) label 10, server, 2 (AI engine B) label 12, or client computer 16 may host, invoke, or coordinate an ingestion workflow that transmits computer-readable data to multiple servers and collects returned outputs for subsequent comparison, matching-value generation, and threshold-based decisioning performed by one or more computing nodes that may be co-located with client computer label 16 or hosted on one of server 1 (AI engine A) label 10, server 2 (AI engine B) label 12, or server N (AI engine N) label 14. Furthermore, the networked deployment of FIG. 1 supports separation of processing domains, versioned deployment of distinct algorithms, and independent scaling of engine compute resources, while maintaining the capability to correlate outputs produced by different servers using communication links L1, L2, and L3. Although FIG. 1 illustrates each server comprising a single AI engine, the invention contemplates an embodiment in which a server includes two or more engines. In addition, the servers can be physically located at a client's location or can be located in the cloud.

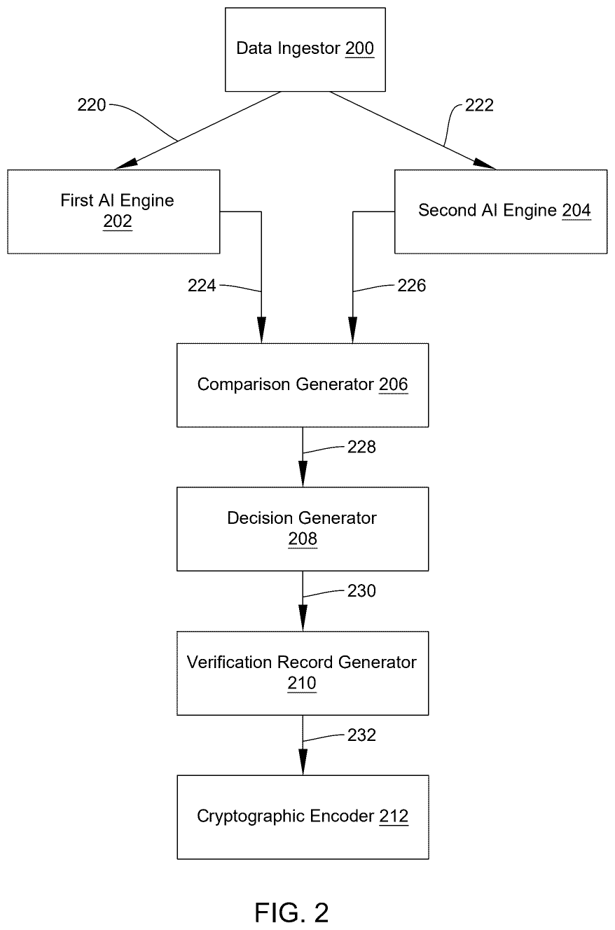

FIG. 2 is a block diagram illustrating an embodiment of an automated data analysis system in which computer-readable data is ingested, processed by two or more different engines, compared, and then routed through decisioning, as well as record-generation and encoding functions. As shown, the system includes a data ingestor 200 coupled upstream of a first AI engine 202 and a second AI engine 204. Outputs from the first AI engine 202 and the second AI engine 204 are coupled to a comparison generator 206, and an output of the comparison generator is coupled downstream to a decision generator 208. The decision generator 208 may optionally be coupled to a verification record generator 210, which in turn could be coupled to an optional cryptographic encoder 212.

According to an embodiment, the data ingestor 200 receives the computer-readable data in the form of an electronic document, a loan file, a document stack, or another machine-readable payload associated with an enterprise workflow. The machine-readable payload can include a scanned image, a PDF, a text document, or a structured data file, including combinations thereof. Additionally, the data ingestor 200 may perform intake handling operations that include normalization of file formats, association of metadata, and generation of correlation identifiers that enable results from parallel processing paths to be reconciled downstream. Furthermore, the data ingestor 200 provides an ingestion output to the first AI engine 202 via path 220 and provides an ingestion output to the second AI engine 204 via path 222, such that both engines receive derived data corresponding to a common ingested input while operating as separate processing paths.

In some embodiments, the first AI engine 202 processes the ingestion output received via path 220 using a first AI algorithm to produce a first result, and the second AI engine 204 processes the ingestion output received via path 222 using a second AI algorithm to produce a second result. The second AI algorithm is substantially uncorrelated or orthogonal, and more preferably uncorrelated or orthogonal, to the first AI algorithm. This supports a trust mechanism in which one AI engine's output is evaluated against the other AI engine's output to provide a sanity check on automated document understanding. As used herein, “substantially uncorrelated” or “substantially orthogonal” means uncorrelatedness or orthogonality of at least 95% percent (i.e., the correlation between their error events must be at most about 0.053). The two algorithms could differ architecturally. For example, the first AI 202 engine may use a deterministic AI algorithm model and the second AI engine 204 may use a probabilistic AI algorithm model.

In one embodiment, the first AI engine 202 may implement a depth-first process that applies domain logic, deterministic parsing, expert-system rules, or a domain-tuned model to extract or classify information from the ingested data and to associate extracted outputs with confidence values and provenance attributes. Furthermore, the first AI engine 202 provides a first AI engine output to the comparison generator via path 224, where the first AI engine output can include one or more extracted fields, document classifications, derived values, and engine-generated confidence indicators, etc.

In one embodiment, the second AI engine 204 may implement a breadth-first algorithm. The breadth-first algorithm could be probabilistic type algorithms, such as the one that uses neural-network processes known in the art. An example of such neural network type algorithm is a large-language-model (LLM) based model, which applies transformer-based inference, natural-language processing, reasoning-oriented processing, or other model-driven techniques to interpret the ingested data. The second AI engine 204 outputs the second result via path 226 to the comparison generator, where the second AI engine output is formatted to support alignment to the first AI engine output for downstream comparison operations. The second result may represent extracted meaning from unstructured content.

In one aspect, comparison generator 206 receives the first AI engine output and the second AI engine output and generates a matching value that represents an extent of agreement between the respective outputs. Additionally, the comparison generator may implement schema alignment, canonicalization, synonym mapping, and equivalence rules so that the extent of agreement could be evaluated based on semantic correspondence rather than surface-level formatting. Furthermore, the comparison generator outputs a comparison generator output to the decision generator 208 via path 228, where the comparison generator output includes the matching value and, in some implementations, supporting comparison artifacts that characterize per-field matches, mismatches, and associated confidence signals.

According to an embodiment, the decision generator label 208 receives the comparison generator output path 228 and executes decision logic that determines an action for the automated analysis event. The decision generator 208 may evaluate the matching value against a policy-defined threshold and, responsive to a threshold condition being satisfied, set a final result equal the matched string, either in a form of the first result or the second result. The decision generator 208 may provide a decision generator output to an optional verification record generator 210 via path 230, where the decision generator output includes the final result and one or more attributes that characterize the decision, including the matching value and any threshold identifier applied during decisioning.

In some embodiments, the verification record generator 210 generates a machine-readable verification record based on the received decision generator output. Additionally, the verification record generator 210 may populate the verification record with event metadata, including document identifiers, timestamps, engine identifiers, algorithm version identifiers, field-level confidence values, and the matching value used by the decision generator 208. The verification record output can be formatted for storage, transmission, audit, or downstream workflow traceability, including as a structured signal such as a JSON-formatted record. The output of verification record generator 210 may optionally be fed into cryptographic encoder 212 via path 232, the latter transforming verification record into secure, human-unreadable format. The cryptographic encoder 212 may be of any type known in the art, such as symmetric type, asymmetric type, and hash function type.

According to an embodiment, the cryptographic encoder 212 receives the verification record output on path 232 and applies one or more cryptographic operations to generate a secured verification artifact. Additionally, the cryptographic encoder 212 may compute a digest across at least a portion of the verification record, generate a digital signature using a signing key associated with an enterprise environment, and encrypt selected fields to control disclosure of extracted information under access-control policy. Furthermore, the secured verification artifact produced by cryptographic encoder 212 may support tamper-evident retention of the analysis event represented in FIG. 2, while enabling independent validation that the recorded outputs correspond to the same processing instance routed through the data ingestor 200, the first AI engine 202, the second AI engine 204, the comparison generator 206, and the decision generator 208.

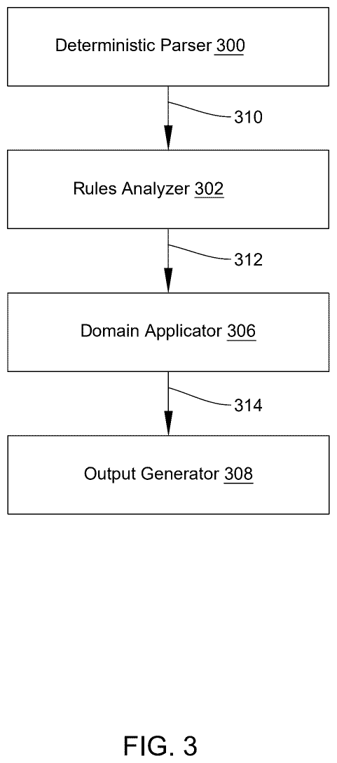

FIG. 3 is a block diagram illustrating a depth-first artificial intelligence engine arranged as a deterministic processing pipeline known in the art that transforms an ingested document representation into a structured engine output. The depth-first artificial intelligence engine of FIG. 3 corresponds to an implementation of the first AI engine configured to output the first result for use by a downstream comparison generator and decision generator. As illustrated, processing progresses from a deterministic parser 300 to a rules analyzer 302, then to a domain applicator 306, and then to an engine output generator 308, with inter-stage data exchanged through output 310 of deterministic parser 300, output 312 of rules analyzer 302, and output 314 of domain applicator output 314.

According to an embodiment, deterministic parser 300 accepts the output 220 of the ingestor 200 and parses the ingested document representation to generate parser output 310 in structured and/or unstructured forms as known in the art. The deterministic parser 300 can execute text-layer parsing, layout-aware extraction, optical character recognition post-processing, table segmentation, and key-value candidate generation to produce structured parse artifacts. Furthermore, parser output 310 can include extracted field candidates, token spans, positional coordinates, page references, and parsing diagnostics that support later interpretation stages, with such artifacts being formatted to preserve traceability from extracted values back to source regions of the electronic document.

According to an embodiment, the rules analyzer 302 generates rules analysis output 312 that conveys rule-evaluation results used to drive domain application behavior. For example, rules analyzer may include a rule that a zip code of an address must be a string of five digits and another rule that a telephone area code must be a string of three digits. Additionally, rules analysis output 312 can encode a document-type hypothesis, a parsing profile identifier, expected field sets for a target workflow, and constraint expressions associated with domain logic. Furthermore, rules analysis output 312 can include directives for selecting extraction anchors, page regions, template identifiers, and normalization transformations, thereby enabling the domain applicator 306 to apply repeatable domain-specific operations for a given electronic document and associated metadata.

According to an embodiment, domain applicator 306 receives parser output 312 and applies an appropriate domain logic to interpret, refine, and validate parsed artifacts to form domain applicator output 314. For example, for mortgage applications, the domain applicator may apply loan-processing domain, while for medical records the domain applicator may apply healthcare-processing domain. Additionally, domain applicator 306 can evaluate cross-field relationships and consistency constraints, including constraints that relate dates to periods, amounts to units, and identifiers to borrower or transaction entities represented in the electronic document. Furthermore, domain applicator output 314 can include resolved field values, derived values computed from parsed inputs, field-level status indicators, and associated confidence values, with the confidence values being generated from one or more of parse diagnostics, rule satisfaction, and constraint-evaluation outcomes.

In one aspect, engine output generator 308 transforms domain applicator output 314 into a machine-readable first AI engine output (reference 224 in FIG. 2) in a predetermined schema for downstream comparison against a second AI engine output (reference 226 in FIG. 2). Additionally, engine output generator 308 can normalize data formats, such as formats for names, addresses, dates, and currency values; assign canonical field identifiers; and attach provenance metadata identifying source pages, regions, and parsing directives that contributed to each extracted field. The first AI engine output generated by engine output generator 308 is routed to a comparison generator (reference 206 in FIG. 2) as a first result, enabling computation of a matching value and threshold-based selection of a final result in the multi-engine architecture of the present invention.

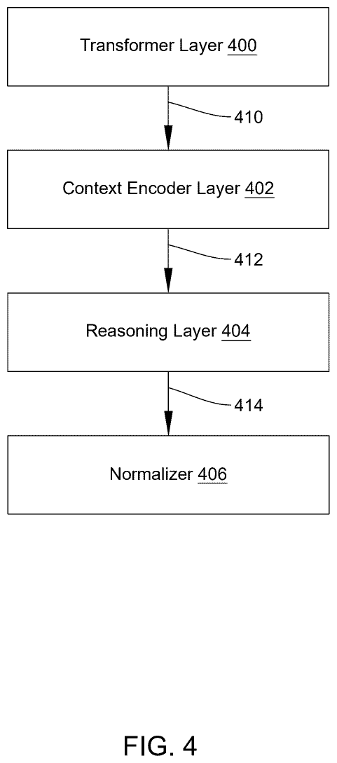

FIG. 4 is a block diagram illustrating a breadth-first artificial intelligence engine arranged as a probabilistic neural-network-type layered processing pipeline that converts an ingested document representation into a normalized engine output for downstream comparison and decisioning. The breadth-first AI engine includes a transformer layer 400 positioned upstream of a context encoder layer 402, a reasoning layer 404 positioned downstream of context encoder layer 402, and a normalizer 406 positioned downstream of reasoning layer 404. The figure further depicts staged data transfers, as transformer output 410 is outputted from transformer 400 to context encoder layer 402, context encoder output 412 is outputted from context encoder layer 402 to reasoning layer 404, and reasoning layer output 414 is outputted from reasoning layer 404 to normalizer 406, thereby illustrating a sequential processing path from context enrichment through model inference, reasoning, and schema alignment.

According to an embodiment, transformer layer 400 receives a document representation derived from computer-readable data provided by an ingestion module and generates transformer output 410. Transformer layer 400 tokenizes text, derived from the computer-readable data, by converting text to numbers one token at a time. As is known in the art, a token is the smallest unit of text, which can be a single character, a whole word, or part of a word.

According to an embodiment, context encoder 402 consumes output 410 of transformer layer 400 and generates context-layer output 410. Context encoder 402 tags each word with its position within the input text and to figure out word relationships.

Reasoning layer 404 receives context encoder output 412 and uses it to break complex problems into multiple smaller, logical, steps, called chain-of-thought steps known in the art. Reasoning layer 404 generates a reasoning layer output 414.

Normalizer 406 receives the reasoning layer output 414 and emits a normalized second result that is aligned to a comparison schema used by a downstream comparison generator (reference 206 in FIG. 2). Additionally, normalizer 406 may map fields represented in reasoning layer output 414 to canonical field identifiers, normalize representations for names, addresses, dates, and currency values, and align data types and units to a shared schema, so that the second result would be comparable to a first result produced by the first artificial intelligence engine.

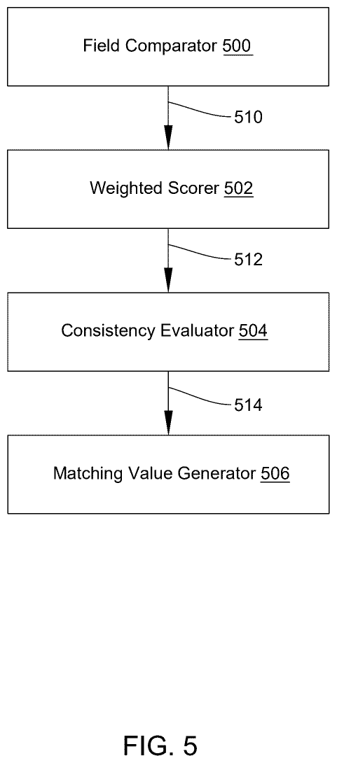

FIG. 5 illustrates an example implementation of comparison generator that produces a matching value for use by downstream decisioning. The flow diagram depicts a sequence of operations including field comparator 500, weighted scorer 502, consistency evaluator 504, and matching value generator 506, arranged in a processing order from top to bottom. As illustrated, output 510 of the field comparator 500 feeds weighted scorer 502, output 512 of the weighted scorer 502 feeds consistency evaluator 504, and output 514 of the consistency evaluator 504 feeds matching value generator 506. In this arrangement, FIG. 5 provides processing detail for a comparison generator 206 (FIG. 2) that receives a first result from a first AI engine and a second result from a second AI engine, and then produces a matching value based on an extent of agreement between the first result and the second result.

According to an embodiment, field comparator 500 accesses at least a portion of the first result and at least a portion of the second result and performs field-level comparison using a shared comparison schema. Additionally, field comparator 500 can include alignment logic that maps each engine output into the shared comparison schema using canonical field identifiers, data-type normalization, and value canonicalization, such as normalization of names, addresses, dates, and currency values. For example, field comparator may use string matching heuristics to normalize for street names, company names, dates, and amounts. The followings may be considered equivalent representations: Court vs. Ct.; Street vs. St.; Company vs. Company LLC; Company vs. Company Corp.; Mar. 23, 2026 vs. 03-23-2026 vs. Mar. 23, 2026; $,2035.00 vs. $2035.00 vs. $2035. Field comparator may also use known approximate string-matching algorithms, such as Levinstein algorithm, for equivalence determinations. For example, strings “insure” and “insurer” may be treated as equivalent. Delimiters in certain strings, such as social security numbers (e.g., 227-80-6998 vs. 227806998) and telephone numbers (e.g., 516 385 5987 vs. (516) 38505987) may be ignored.

Furthermore, field comparator 500 may compute, for each compared field, a match indicator, a mismatch indicator, or a similarity score, and may associate such per-field comparison artifacts with references to source fields in the respective engine outputs. The per-field comparison artifacts are conveyed as output of the field comparator 510 to weighted scorer 502.

In some embodiments, weighted scorer 502 transforms the per-field comparison artifacts into one or more intermediate agreement measures using weighting parameters. Additionally, the weighting parameters can be selected based on file type, document type, workflow context, or a downstream use of extracted values, such that certain fields contribute more heavily to a computed agreement measure than other fields. Furthermore, weighted scorer 502 may apply scoring adjustments for missing fields, conflicting values, or format-inconsistent values detected by field comparator 500 and may propagate confidence (uncertainty) indicators derived from one or both engine outputs. The resulting intermediate score information is conveyed as output 512 of the weighted scorer 502 to consistency evaluator 504.

For example, if two strings match exactly, the system may assign a score of 100. The system may also assign a weighted score of 100 in cases where two strings are considered equivalent representations, such as in Street and St., as well as the other examples provided above. At the same time, if the two strings being compared do not match exactly and are not considered equivalent, the assigned weighted score could be made equal to a confidence value that is the greater of the (i) confidence value of the first result output, and (ii) confidence value of the second result output. In one embodiment, the weighted score could be made even less than the value assigned using the schema described in the preceding sentence.

According to an embodiment, consistency evaluator 504 evaluates the intermediate score information against one or more consistency constraints associated with a target processing domain. Additionally, consistency evaluator 504 may perform cross-field checks that evaluate whether field combinations satisfy domain constraints, including checks that relate identity fields across multiple pages, checks that relate amounts to declared frequency, and checks that relate date ranges to represented periods. Furthermore, consistency evaluator 504 can generate constraint-evaluation artifacts, including identifiers of evaluated constraints, identifiers of any violated constraints, and an adjustment factor for the intermediate agreement measures based on detected inconsistencies. The evaluation results are outputted as output 514 of the consistency evaluator 504 and provided to matching value generator 506.

In one aspect, matching value generator 506 computes a matching value based on the output 514 of the consistency evaluator 504. Additionally, the matching value can be represented as a scalar value, a bounded score, or a structured matching object that includes a numeric component and supporting attributes that characterize sources of agreement and disagreement. For example, although two strings may match exactly or may be equivalents, if the confidence values of the first and second results are low, matching value may be assigned a low number. Furthermore, the matching value produced by the matching value generator 506 is configured for use by downstream threshold decision logic to determine whether to accept one of the first AI engine output or the second AI engine output as a final result or, alternatively, to escalate the event for further processing, either by a human reviewer or by a third AI engine running a third AI algorithm that is substantially uncorrelated to both first and second AI algorithms.

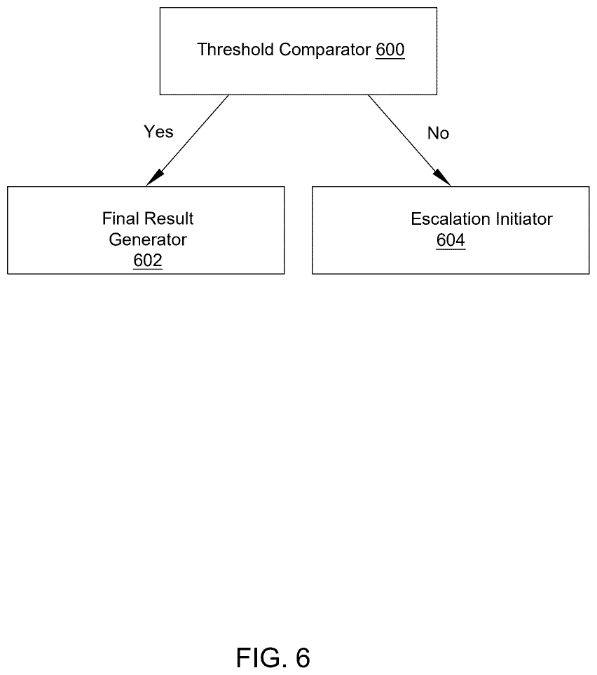

FIG. 6 corresponds to operations of decision generator 208 described with respect to FIG. 2 and uses the matching value as an agreement signal between the first result generated by a first AI engine 202 and the second result generated by the second AI engine 204. In one aspect, FIG. 6 is a flow diagram showing a threshold comparator 600 evaluating the matching value against a threshold value to determine whether an automated processing event should be accepted for downstream use or whether it should be diverted for escalated handling. For example, if threshold comparator 600 determines that the matching value is above the threshold (in some embodiments it could be equal or greater than threshold), the system proceeds along the “Yes” arrow in FIG. 6 to a final result generator 602. Final result generator 602 assigns one of the first AI engine result 224 or the second AI engine result 226 to be the final result. On the other hand, if the matching value is not above the threshold (in some embodiments it could be less than threshold), the system proceeds along the “No” arrow in FIG. 6 to an escalation initiator 604, which can automatically submit the computer-readable file for analysis by a third AI engine running an AI algorithm that is orthogonal or substantially orthogonal to both first and second AI algorithms. Alternatively, escalation initiator may forward the file to a human reviewer for manual analysis.

According to an embodiment, threshold comparator 600 retrieves or otherwise accesses a threshold value associated with a processing context for the ingested computer-readable data, such as an electronic document or loan file. The threshold value could be fixed, or it could be selected (calculated) based on metadata associated with the processing request, including a document type, a workflow stage, a downstream use of one or more extracted fields, an identified data source, or an execution policy tied to an enterprise tenant. Furthermore, threshold comparator 600 implements comparison logic that evaluates whether the matching value satisfies an acceptance condition, where the acceptance condition includes a relational test between the matching value and the threshold, and where the acceptance condition is evaluated using one or more of a scalar threshold, a field-specific set of thresholds, or a rule expression that consumes both a numeric matching score and accompanying comparison artifacts received from the comparison generator.

In some embodiments, responsive to threshold comparator 600 indicating that the acceptance condition is satisfied, final result generator 602 generates a final processing result for downstream consumption. The final processing result may be set equal to the first result 224 of the first AI engine 202 or the second result 226 of the second AI engine 204, consistent with the method operations described herein. Furthermore, final result generator 602 can associate the final processing result with a final confidence value derived from one or more of the first result 224, the second result 226, and the matching value, such that the final confidence value exceeds at least one of a confidence value associated with the first result 224 or a confidence value associated with the second result 226, thereby supporting automated passthrough of the final processing result to downstream modules without introducing a manual verification step at this stage of processing.

According to an embodiment, responsive to threshold comparator 600 indicating that the acceptance condition is not satisfied, escalation initiator 604 initiates an escalation action that routes the processing event for further analysis. Additionally, the escalation action can include generating an exception object that identifies one or more fields contributing to non-agreement, attaching per-field comparison artifacts and consistency-evaluation outcomes produced by the comparison generator, and associating an escalation reason code with the event. Furthermore, escalation initator 604 can route the electronic document and associated artifacts to a secondary processing pipeline, a reprocessing workflow using alternate configuration settings, or a review queue, while preserving correlation identifiers that link the escalation to the first result, the second result, and the matching value that was evaluated by threshold comparator 600.

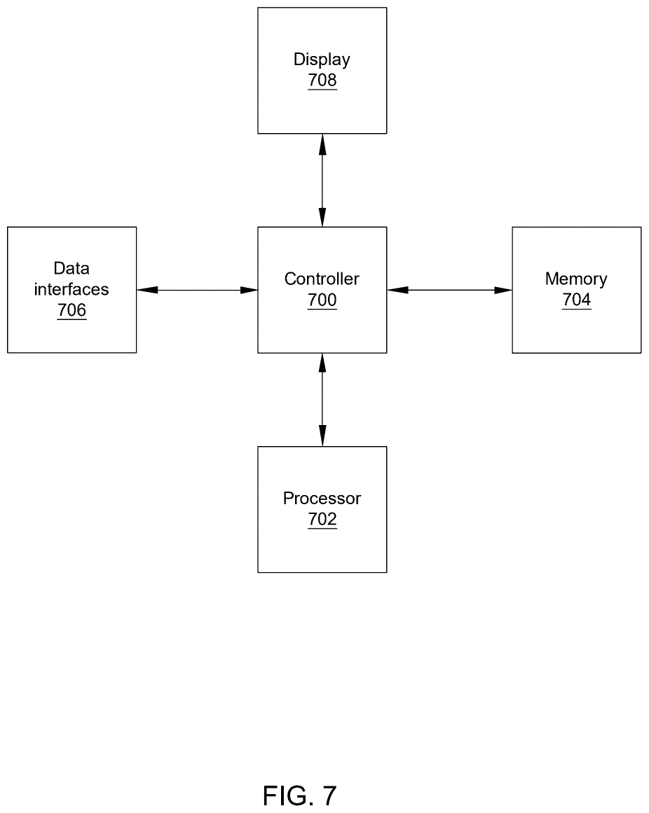

FIG. 7 is a block diagram illustrating an example server architecture that executes one or more portions of the automated data-processing workflow described with respect to FIGS. 1-6. The server includes controller 700 coupled to processor 702, memory 704, data interfaces 706, and display 708. The illustrated couplings represent one or more internal buses, interconnects, or message-passing links by which controller 700 coordinates execution of software instructions by processor 702, exchanges data with memory 704, transmits and receives data via data interfaces 706, and provides operational status via display 708.

According to an embodiment, controller 700 implements control logic that schedules, sequences, or dispatches operations associated with ingestion, multi-engine processing, comparison generation, and decision generation, including correlation of outputs produced by different processing paths. Additionally, controller 700 manages workflow context for a given processing event, including one or more identifiers that associate an ingested electronic document with a first processing result, a second processing result, a matching value, and a final result produced in response to a threshold evaluation. Furthermore, controller 700 coordinates concurrent execution contexts for the different engines, including issuing parallel invocations and collecting returned results for downstream comparison and threshold logic.

In some embodiments, processor 702 executes computer-readable instructions that implement one or more functional blocks disclosed herein, including intake handling, document parsing, model inference, schema mapping, matching-value generation, verification-record generation, and cryptographic securing of one or more artifacts. Additionally, processor 702 includes one or more processing cores selected for workloads associated with rule evaluation and deterministic parsing, and for workloads associated with transformer inference and similarity scoring. Furthermore, processor 702 executes multiple threads or processes for separate engine instances such that processing of a common electronic document by uncorrelated algorithms occurs in distinct execution contexts whose results are collected by controller 700.

According to an embodiment, memory 704 stores executable program code and data used by the server during execution of the automated data-processing workflow. Additionally, memory 704 stores one or more of document binaries, normalized document representations, parsed tokens, extracted field-value pairs, model parameters, rule sets, prompts, and schema definitions used by the different AI engines. Furthermore, memory 704 stores intermediate and final artifacts associated with comparison and decision operations, including per-field comparison outputs, weighting parameters, threshold configuration values, exception objects for escalated handling, and verification records formatted as structured data objects.

In one aspect, data interfaces 706 provide communication pathways between the server and external computing systems that provide inputs to, or consume outputs from, the automated data analysis workflow. Additionally, data interfaces 706 include one or more network interface controllers, storage interfaces, and inter-process communication endpoints for receiving electronic documents or document references from upstream systems and for transmitting structured outputs and verification artifacts to downstream enterprise applications. Furthermore, data interfaces 706 support exchange of first results and second results with distributed computing nodes that execute different AI engines, and support retrieval of internal records or third-party records used for validation operations and for cross-check operations reflected in a matching value computed by a comparison generator.

In some embodiments, display 708 presents operational information associated with execution of the workflow on the server. Additionally, display 708 renders status indicators corresponding to ingestion events, per-engine processing states, comparison outcomes, threshold evaluations, and routing outcomes associated with generating a final result or initiating escalated handling. Furthermore, display 708 presents diagnostic information including engine identifiers, algorithm version identifiers, timestamps, document identifiers, and processing metrics retrieved from memory 704 under control of controller 700, thereby supporting monitoring and administrative review of processing events while underlying artifacts are exchanged through data interfaces 706.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

Because individual structures (implemented in programming instructions, circuits, or their combinations) for performing the various steps of the invented method, such as “receiving,” “obtaining”, “selecting,” “classifying”, “grouping”, “identifying,” “determining,” “comparing”, “applying”, and “adjusting” are known to one skilled in the art, the steps have been disclosed at a logical (flow chart) level only, and further details are not necessary for making and using the invention.

Unless stated otherwise, terms such as “first” and “second” are used to arbitrarily distinguish between the elements such terms describe. Thus, these terms are not necessarily intended to indicate temporal or other prioritization of such elements.

Unless otherwise stated, conditional terms such as “can”, “could”, “will”, “might”, or “may” are understood within the context as used in general to convey that certain embodiments include, while other embodiments do not include, certain features and/or elements. Thus, such conditional terms are not generally intended to imply that features and/or elements are in any way required for one or more embodiments.

It will be understood by those within the art that, in general, terms used herein, are generally intended as “open” terms (e.g., the term “including” should be interpreted as “including but not limited to”, the term “having” should be interpreted as “having at least”, the term “includes” should be interpreted as “includes but is not limited to”, etc.).

1. An automated data analysis system comprising:
a data ingestor configured to receive a computer-readable data;
a first artificial intelligence (AI) engine coupled to the data ingestor and configured to process the received computer-readable data using a first AI algorithm to produce a first result;
a second AI engine coupled to the data injector configured to process the received computer-readable data, to produce a second result, using a second AI algorithm that is substantially uncorrelated to the first AI algorithm;
a comparison generator coupled to the first AI engine and to the second AI engine, the comparison generator configured to generate a matching value based on the first result and the second result; and
a decision generator coupled to the comparison generator and configured to generate a final result,
wherein the final result has a final confidence value that is greater than at least one of (i) a confidence value of the first result and (ii) a confidence value of the second result.

2. The automated data analysis system of claim 1, wherein the first AI algorithm is a depth-first AI algorithm and the second AI algorithm is a breadth-first AI algorithm.

3. The automated data analysis system of claim 2, wherein the depth-first artificial intelligence algorithm is an expert-system algorithm; and wherein the breadth-first AI algorithm is a large-language-model (LLM) algorithm.

4. The automated data analysis system of claim 3, wherein the breadth-first AI engine includes a transformer layer.

5. The automated data analysis system of claim 1, further comprising a verification-record generator coupled to an output of the decision generator.

6. The automated data analysis system of claim 5, wherein the verification-record generator is configured to produce a signal having a JSON format.

7. The automated data analysis system of claim 1, further comprising a cryptographic encoder.

8. The automated data analysis system of claim 4, wherein the depth-first AI engine includes a rules analyzer.

9. The automated data analysis system of claim 1, wherein the computer-readable data is a loan file.

10. An automated data analysis method comprising:
receiving a computer-readable data;
processing the received computer-readable data using a first artificial intelligence (AI) engine to produce a first result having a first confidence value, the first AI engine running a first AI algorithm;
separately processing the received computer-readable data using a second AI engine to produce a second result having a second confidence value, the second AI engine running a second AI algorithm that is substantially uncorrelated to the first AI algorithm;
analyzing the first result and the second result to produce a matching value; and
based on the matching value produce a final result;
wherein the final result has a final confidence value that is greater than at least one of (i) the first confidence value and (ii) the second confidence value.

11. The automated data analysis method of claim 10, wherein the first AI algorithm is a depth-first AI algorithm and the second AI algorithm is a breadth-first AI algorithm.

12. The automated data analysis method of claim 11, wherein the depth-first artificial intelligence algorithm is an expert-system algorithm; and
wherein the breadth-first AI algorithm is a large-language-model (LLM) algorithm.

13. The automated data analysis method of claim 12, wherein the breadth-first AI engine includes a transformer layer.

14. The automated data analysis method of claim 10, further comprising the step of generating a verification record.

15. The automated data analysis method of claim 14, wherein the verification record has a JSON format.

16. The automated data analysis method of claim 10, further comprising the step of cryptographically securing the final result.

17. The automated data analysis method of claim 10, wherein the computer-readable data is a loan file.

18. An automated data analysis system comprising:
a data ingestor configured to receive a computer-readable data;
a first artificial intelligence (AI) engine coupled to the data ingestor and configured to process the received computer-readable data using a first AI algorithm to produce a first result;
a second AI engine coupled to the data ingestor and configured to process the received computer-readable data, to produce a second result using a second AI algorithm that is substantially uncorrelated to the first AI algorithm; and
a decision generator coupled to the first AI engine and the second AI engine, the decision generator configured to generate a final result based on the first result and the second result.

19. The automated data analysis system of claim 18, wherein the first AI algorithm is a depth-first AI algorithm and the second AI algorithm is a breadth-first AI algorithm.

20. The automated data analysis system of claim 18, wherein the first AI algorithm is a deterministic algorithm and the second AI algorithm is a probabilistic algorithm.
